(19) United States
(12) Patent Application Publication
(10) Pub. No.: US 2006/0242790 A1
(43) Pub. Date: Nov. 2, 2006

(54) Holding device for sliding doors

(76) Inventor: Uwe Lauterbach, Schwaig (DE)

Correspondence Address: LACKENBACH SIEGEL, LLP, LACKENBACH SIEGEL BUILDING, 1 CHASE ROAD, SCARSDALE, NY, 10583, US

(21) Appl. No.: 10/558,141

(22) PCT Filed: May 24, 2004
(86) PCT No.: PCT/DE04/01089

§ 371 Date: Nov. 22, 2005

(30) Foreign Application Priority Data
May 22, 2003 (DE) 203 08 204.4

(51) Int. Cl. E05D 15/06

(52) U.S. Cl. 16/93 R

(57) ABSTRACT

The invention relates to a holding device for sliding doors, particularly for sliding doors having glass panes, metal panels or plastic panels, comprised of a holding part, which is placed over an edge or corner of the pane/panel, whereby the holding part rests via a pair of walls against a front and rear side of the edge or of a corner of the pane/panel. At least one wall has a threaded hole for a flat screw. An elastic layer is provided at least between the end of the flat screw and the pane/panel. The flat screw may be threadably adjusted relative to the threaded hole from the outside while exerting a force that compresses the elastic layer, and a roller for a guide track is mounted on the flat screw in a manner enabling desirable rotation.

The present invention relates to a holding device for sliding doors, particularly for sliding doors having glass panes, metal panels or plastic panels, having the characteristics of the precharacterizing portion of claim 1.

A holding device for a sliding door of a shower unit comprising a holding part placed over an edge of the sliding door, wherein the holding part comprises a guide means for guiding the sliding door inside an upper guide track, and wherein the holding part rests via walls against the front and rear of the upper edge of the sliding door, and at least one back part joins the front wall and back wall of the holding part at least over the upper or lower edge of the sliding door, is known from German patent document DE-C-38 00 444. There, the connection between the pane and the holding device is created by means of gluing. This is also known, for example, from U.S. Pat. No. 6,041,551. In the case of glued connections, problems can occur through loosening caused by aging, and as long as the adhesive connection still holds, it is virtually impossible to replace the pane/panel without damaging the holding device or pane/panel. To remedy this, holes are drilled into the panes/panels in practice, so that screw connections can be created. In the case of glass panes, this can cause breakage as early as during the drilling process, but also during the assembly, with breakage involving drilled panes resulting in greater damage. From German patent document DE-U-202 07 245, a holding device (1) is known for sliding doors, particularly for sliding doors having glass panes, metal panels or plastic panels, comprising a holding part, which is placed over an edge or corner of the pane/panel, wherein the holding part comprises a guide means for guiding the sliding door inside an upper or lower guide track, wherein the holding part rests via walls against the front and rear of the edge or of the corner of the pane/panel, and at least one back or joining part joins the front wall and rear wall of the holding part at least over the upper or lower edge of the pane/panel, wherein at least one wall has a threaded bore for a flat screw, wherein an elastic layer is provided at least between the end of the flat screw and the pane/panel, and wherein the flat screw can be screwed into the threaded bore from the outside while exerting a force that compresses the elastic layer.

It is the object of the present invention to simplify a holding device for sliding doors having glass panes, metal panels or plastic panels of the last-mentioned type in such a way that particularly the injection-molded guide element may be eliminated and the holding device has smaller dimensions overall.

This object is met with the features of the characterizing portion of claim 1. Improvements and advantageous embodiments of the invention are covered by the additional claims.

[Provided]¹ according to the invention, [is] a holding device for sliding doors, particularly for sliding doors having glass panes, metal panels or plastic panels, comprising a holding part, which is placed over an edge or corner of the pane/panel, wherein the holding part rests via walls against the front and rear of the edge or of the corner of the pane/panel, and at least one back or joining part joins the front wall and rear wall of the holding part at least over the upper or lower edge of the pane/panel, wherein at least one wall has a threaded bore for a flat screw, wherein an elastic layer is provided at least between the end of the flat screw and the pane/panel, and wherein the flat screw can be screwed into the threaded bore from the outside while exerting a force that compresses the elastic layer, characterized in that a roller for a guide track is rotatably disposed on the flat screw.
Translator's note: words in square brackets have been added by the translator.

The roller preferably has a circumferential V-shaped groove (8) and the elastic layer is preferably an insert composed of an elastomeric material.

According to one embodiment of the invention, the elastic layer is disposed between the at least one wall and the pane/panel. Alternatively, the elastic layer is disposed between both walls and the at least one back part. According to yet another alternative, the elastic layer is applied to the end of the flat screw.

According to one embodiment of the invention, a second back part joins the walls over the side edge of the pane/panel.

The threaded bore is preferably provided on the back wall.

According to a preferred embodiment of the invention, the walls are shaped substantially triangular, having a right angle at the edge between the upper or lower edge of the pane/panel and its side edge. The leg of the triangle opposite said right angle may have an outwardly curved arch. The threaded bore for the flat screw is provided essentially centered on the wall.

A preferred embodiment of the invention will be described below by way of example, based on drawings in which:

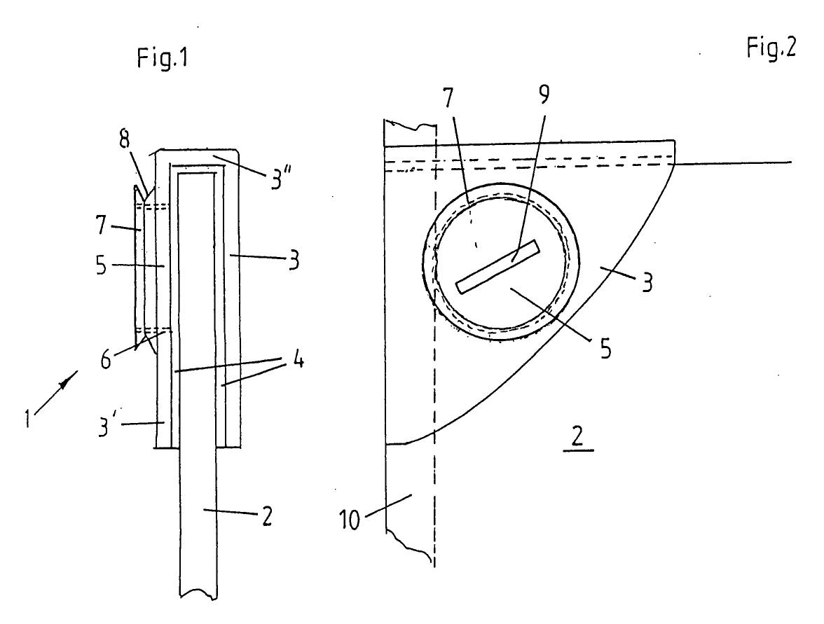

FIG. 1 shows a view from the side onto the upper end of a sliding door with a guide track;

FIG. 2 shows a front view onto the upper corner of the sliding door of FIG. 1.

FIGS. 1 and 2 show a holding device 1 for a sliding door having a glass pane 2. The holding device consists of a slip-on part having a front wall 3, a rear wall 3′, and a joining part 3″, which is placed over an edge of a glass pane 2. Disposed between the pane 2 and the slip-on part is a layer 4 composed of an elastomeric material. The rear wall 3′ of the slip-on part has a threaded bore 6 having a relatively large diameter, into which a flat screw 5 with a blunt end is screwed. In FIG. 2 it is apparent that the front wall 3 has an approximately triangular shape. The rear wall is preferably implemented congruent with the former. Held on the flat screw 5 in a manner that enables it to rotate but remain captive, e.g., inside a groove, is a roller 7, which runs with a circumferential V-shaped groove on the guide track of a piece of furniture. The flat screw 5 has a slot 9 for tightening, the threads of the flat screw 5 and of the wall bore 6 being executed such that they become largely wedged or clamped together in the end position when the screw 5 is screwed in. When the screw 5 is tightened it presses with its blunt end over a large surface area onto the layer 4 of elastomeric material and, at the same time, pulls in the opposed front wall, so that a very tight but releasable seat of the holding device 1 on the pane 2 is ensured.

What is claimed is:

1.-11. (canceled)

12. A holding device for securely guiding a movable member relative to a guide track, said holding device comprising:
a first and a second opposed wall member positionable on opposing side portions of said movable member;
a third joining member connectively securing said first wall member relative to said second wall member about an edge of said moveable member;
means for threadably securing said holding device to said moveable member by pressing on at least a part of one of said opposing side portions of said moveable member with a compressive urging;
said means for threadably securing in at least one of said first and second opposed wall members;
said means for threadably securing further comprising:
roller means for guiding said holding device and said threadably secured movable member relative to said guide track; and
said roller means being rotatably disposed on said means for threadably securing, whereby said roller means for guiding and said means for threadably securing enable a secure guiding of said moveable member relative to said guide track with a low profile and compact shape.

13. A holding device for securely guiding a movable member relative to a guide track, according to claim 12, wherein:
said means for threadably securing said holding device to said moveable member further comprises:
at least a first threaded bore in one of said first and said second opposed wall members;
at least a first threaded member threadably securable within said at least first threaded bore relative to said one of said first and said second opposed wall members, thereby enabling said compressive urging of said movable member to secure said holding device relative thereto;
at least a first roller member rotatably disposed on an outer end said at least first threaded member; and
said at least first roller member engaging said guide track during a use for guiding said moveable member.

14. A holding device for securely guiding a movable member relative to a guide track, according to claim 13, wherein:
said at least first roller member includes a circumferentially disposed engaging geometry for guidably receiving a portion of said guide track therein; and
said engaging geometry being at least one of a concave geometry and a V-shaped groove geometry, whereby said roller member and said engaging geometry engage said guide track and resist relative lateral displacement thereto during motion of said moveable member along said guide track.

15. A holding device for securely guiding a movable member relative to a guide track, according to claim 14, wherein:
said holding device further comprises:
at least an elastomeric member between an inner end of said at least first threaded member and said at least one of said opposing side portions of said moveable member, whereby said elastomeric member enables a transmission of said compressive urging to secure said holding device to said movable member within an improved reliability and a minimization of damage to said movable member.

16. A holding device for securely guiding a movable member relative to a guide track, according to claim 13, wherein:
said holding device further comprises:
at least one elastomeric member between at least one of said first and second wall members and said one of said opposing side portions of said moveable member.

17. A holding device for securely guiding a movable member relative to a guide track, according to claim 13, wherein:
said holding device further comprises:
an elastomeric member between said first and said second wall members and respective said opposing side portions of said moveable member.

18. A holding device for securely guiding a movable member relative to a guide track, according to claim 17, wherein:
said holding device further comprises:
at least an elastomeric member between third joining member and an edge of said moveable member.

19. A holding device for securely guiding a movable member relative to a guide track, according to claim 13, wherein:
said holding device is positioned proximate a right angle end corner of said movable member;
respective outer edges of said first and said second opposed wall members at right angles relative to each other, whereby said holding device is readily secured at said end corner of said movable member.

20. A holding device for securely guiding a movable member relative to a guide track, according to claim 19, wherein:
said first and said second opposed wall members of said holding device are substantially triangular relative to a surface of said moveable member.

21. A holding device for securely guiding a movable member relative to a guide track, according to claim 20, wherein:
legs of respective triangular first and second opposed wall members are joined by an outwardly curved arch.

22. A holding device for securely guiding a movable member relative to a guide track, according to claim 13, wherein:
said threaded bore on said one of said first and said second opposed wall members being substantially centered on said at least one wall member.

23. A holding device for securely guiding a movable member relative to a guide track, said holding device comprising:
a first and a second opposed wall member positionable on opposing side portions of said movable member;
a third joining member connectively securing said first wall member relative to said second wall member about an edge of said moveable member;
means for threadably securing said holding device to said moveable member by pressing on at least a part of one of said opposing side portions of said moveable member with a compressive urging;
said means for threadably securing in at least one of said first and second opposed wall members;
said means for threadably securing further comprising:
roller means for guiding said holding device and said threadably secured movable member relative to said guide track;
said roller means being rotatably disposed on said means for threadably securing,
at least a first threaded bore in one of said first and said second opposed wall members;
at least a first threaded member threadably securable within said at least first threaded bore relative to said one of said first and said second opposed wall members, thereby enabling said compressive urging of said movable member to secure said holding device relative thereto;
at least a first roller member rotatably disposed on an outer end said at least first threaded member; and
said at least first roller member engaging said guide track during a use for guiding said moveable member.

24. A holding device for securely guiding a movable member relative to a guide track, according to claim 23, wherein:
said holding device further comprises:
at least an elastomeric member between an inner end of said at least first threaded member and said at least one of said opposing side portions of said moveable member, whereby said elastomeric member enables a transmission of said compressive urging to secure said holding device to said movable member within an improved reliability and a minimization of damage to said movable member.

25. A holding device for securely guiding a movable member relative to a guide track, according to claim 24, wherein:
said at least first roller member includes a circumferentially disposed engaging geometry for guidably receiving a portion of said guide track therein; and
said engaging geometry being at least one of a concave geometry and a V-shaped groove geometry, whereby said roller member and said engaging geometry engage said guide track and resist relative lateral displacement thereto during motion of said moveable member along said guide track.

26. A holding device for securely guiding a movable member relative to a guide track, said holding device comprising:
a first and a second opposed wall member positionable on opposing side portions of said movable member;
a third joining member connectively securing said first wall member relative to said second wall member about an edge of said moveable member;
means for threadably securing said holding device to said moveable member by pressing on at least a part of one of said opposing side portions of said moveable member with a compressive urging;
said means for threadably securing in at least one of said first and second opposed wall members;
said means for threadably securing further comprising:
roller means for guiding said holding device and said threadably secured movable member relative to said guide track;
said roller means being rotatably disposed on said means for threadably securing,
at least a first threaded bore in one of said first and said second opposed wall members;
at least a first threaded member threadably securable within said at least first threaded bore relative to said one of said first and said second opposed wall members, thereby enabling said compressive urging of said movable member to secure said holding device relative thereto;
at least a first roller member rotatably disposed on an outer end said at least first threaded member;
said at least first roller member engaging said guide track during a use for guiding said moveable member; and
at least one elastomeric member between at least one of said first and second wall members said side portions of said movable member.

27. A holding device for securely guiding a movable member relative to a guide track, according to claim 26, said holding device comprising:
at least a portion of said at least one an elastomeric member between an inner end of said at least first threaded member and said at least one of said opposing side portions of said moveable member, whereby said elastomeric member enables a transmission of said compressive urging to secure said holding device to said movable member within an improved reliability and a minimization of damage to said movable member.
